(19) United States
(12) Patent Application Publication
(10) Pub. No.: US 2024/0378165 A1
(43) Pub. Date: Nov. 14, 2024

(54) NETWORK INTERFACE DEVICE, SYSTEM FOR SUPPORTING OPTICAL NETWORK, AND METHOD OF OPERATING THE SYSTEM

(71) Applicant: ELECTRONICS AND TELECOMMUNICATIONS RESEARCH INSTITUTE, Daejeon (KR)

(72) Inventors: Daeub KIM, Daejeon (KR); Jongtae SONG, Daejeon (KR); Bup Joong KIM, Daejeon (KR); Chanho PARK, Sejong-si (KR); Ji Wook YOUN, Daejeon (KR); Joon Ki LEE, Sejong-si (KR); Kyeong-Eun HAN, Daejeon (KR)

(21) Appl. No.: 18/238,275

(22) Filed: Aug. 25, 2023

(30) Foreign Application Priority Data
May 9, 2023 (KR) 10-2023-0059848

(51) Int. Cl. G06F 13/42

(52) U.S. Cl. CPC G06F 13/4221; G06F 2213/0026

(57) ABSTRACT

A method of operating a link enhancement layer includes generating an expandable flexible flit related to a request or a response of a compute express link (CXL) transaction layer, and transmitting the expandable flexible flit to another link enhancement layer connected to the link enhancement layer. The expandable flexible flit is terminated in the other link enhancement layer.

### CROSS-REFERENCE TO RELATED APPLICATION

This application claims the benefit of Korean Patent Application No. 10-2023-0059848 filed on May 9, 2023, in the Korean Intellectual Property Office, the entire disclosure of which is incorporated herein by reference for all purposes.

### BACKGROUND

### 1. Field of the Invention

The following disclosure relates to a network interface device, a system for supporting an optical network, and a method of operating the system.

### 2. Description of Related Art

A computing system may provide various information technology (IT) services to a user. As the volume of data processed by a computing system has increased, the importance of improving the data processing speed has increased. To provide various IT services, the computing system has been developed in a heterogeneous computing environment. Recently, in the heterogeneous computing environment, various techniques have been developed for accelerating the data processing speed.

A network interface chip or a network interface card (NIC) for memory access, connection between computing resources, data communication, network connection, and the like may be a hardware device used to connect a computing resource or a computer to a network for communication. The network interface chip or the NIC for memory access, connection between computing resources, data communication, network connection, and the like may be also referred to as a network interface, a network interface chip, a device connection controller, a network interface controller, a local area network (LAN) card, a physical network interface, a network adapter, a network card, or an ethernet card.

### SUMMARY

According to one embodiment, a method of operating a link enhancement layer, the method includes generating an expandable flexible flit related to a request or a response of a compute express link (CXL) transaction layer, and transmitting the expandable flexible flit to another link enhancement layer connected to the link enhancement layer. The expandable flexible flit is terminated in the other link enhancement layer.

The expandable flexible flit is transmitted or received through an optically networked (ON)-CXL optical physical layer.

The expandable flexible flit includes at least one data header. The expandable flexible flit includes an entirety of cache line data corresponding to the at least one data header to prevent rollover.

The expandable flexible flit includes a limited number of data headers, or a length of the expandable flexible flit is adjustable based on a number of valid data headers.

The expandable flexible flit does not include a data header or cache line data to prevent rollover.

The expandable flexible flit includes an extensible link header including at least one of an information field for distinguishing a CXL protocol, an information field for distinguishing a message type of a flit, an extendable flit length information field including information on the length of an extended flit, and a start flit delimiter for distinguishing a start of a new flit.

The optical physical layer complies with a standard of an optical physical layer of IEEE 802.3 or an optical physical layer of Infiniband.

According to one embodiment, a method of operating an optical network interface (NI), the method includes generating an expandable flexible flit related to a request or a response of a CXL transaction layer through a link enhancement layer, and transmitting the expandable flexible flit to another optical NI connected to the optical NI through an ON-CXL optical physical layer. The expandable flexible flit is terminated in a link enhancement layer of the other optical NI.

The optical NI is able to be operated by interworking with a CXL interface.

The expandable flexible flit includes at least one data header. The expandable flexible flit includes an entirety of cache line data corresponding to the at least one data header to prevent rollover.

The expandable flexible flit includes a limited number of data headers, or a length of the expandable flexible flit is adjustable based on a number of valid data headers.

The expandable flexible flit does not include a data header or cache line data to prevent rollover.

The expandable flexible flit includes an extensible link header including at least one of an information field for distinguishing a CXL protocol, an information field for distinguishing a message type of a flit, an extendable flit length information field including information on the length of an extended flit, and a start flit delimiter for distinguishing a start of a new flit.

The optical physical layer complies with a standard of an optical physical layer of IEEE 802.3 or an optical physical layer of Infiniband.

According to one embodiment, a method of operating an ON-CXL interface, the method includes generating an expandable flexible flit related to a request or a response of a CXL transaction layer through a link enhancement layer, and transmitting the expandable flexible flit to another ON-CXL interface connected to the ON-CXL interface through an ON-CXL optical physical layer. The expandable flexible flit is terminated in a link enhancement layer of the other ON-CXL interface.

The ON-CXL interface is operated in a device supporting CXL protocol instead of a CXL interface.

According to one embodiment, a method of operating an optical network interface card (NIC), the method includes receiving a CXL flit related to a request or a response of a CXL transaction layer, wherein the CXL flit is generated by a first device supporting CXL protocol, converting the CXL flit into an expandable flexible flit through a link enhancement layer, and transmitting the expandable flexible flit to another optical NIC connected to the optical NIC through an ON-CXL optical physical layer. The expandable flexible flit is reconstructed as a CXL flit through a link enhancement layer of the other optical NIC. The reconstructed CXL flit is transmitted to a second device supporting CXL protocol through a CXL interface of the other optical NIC and is terminated by the second device supporting CXL protocol.

The expandable flexible flit includes at least one data header. The expandable flexible flit includes an entirety of cache line data corresponding to the at least one data header to prevent rollover.

The expandable flexible flit includes a limited number of data headers, or a length the expandable flexible flit is adjustable based on the number of valid data headers.

The expandable flexible flit does not include a data header or cache line data to prevent rollover.

The expandable flexible flit includes an extensible link header including at least one of an information field for distinguishing a CXL protocol, an information field for distinguishing a message type of a flit, an extendable flit length information field including information on the length of an extended flit, and a start flit delimiter for distinguishing a start of a new flit.

The optical physical layer complies with a standard of an optical physical layer of IEEE 802.3 or an optical physical layer of Infiniband.

The data header is specified in a CXL protocol and is a request or a response transmitted with all pieces of cache line (or a line of a memory) data.

The device supporting CXL protocol is a device that supports a CXL protocol. The device supporting CXL protocol is divided into a host device and a CXL device (e.g., an accelerator, a memory expander, a device including an attached memory). The device supporting CXL protocol includes a CXL interface or an ON-CXL interface.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a schematic block diagram of an electronic device according to one embodiment;

FIG. 2 is a diagram illustrating peripheral component interconnect express (PCIe) connecting a host device to a peripheral device;

FIGS. 3A and 3B are diagrams illustrating a compute express link (CXL) interface connecting a host device to a peripheral device;

FIG. 4 is a diagram illustrating a CXL protocol;

FIG. 5 is a diagram illustrating a CXL layer;

FIGS. 6A and 6B are diagrams illustrating a CXL flit;

FIGS. 7A and 7B are diagrams illustrating a device supporting CXL protocol to which an optically networked (ON)-CXL interface is applied, according to one embodiment;

FIGS. 8 and 9 are diagrams illustrating an ON-CXL layer configuring an ON-CXL interface and a method of applying the ON-CXL interface, according to one embodiment;

FIG. 10 is a diagram illustrating an extensible link header and an expandable flexible flit, according to one embodiment;

FIGS. 11A to 11C are diagrams illustrating expandable flexible flit according to one embodiment; and

FIGS. 12A to 12D are diagrams illustrating a link enhancement layer, an operating method of an optical network interface (NI), an ON-CXL interface, and an operating method of an optical network interface card (NIC).

### DETAILED DESCRIPTION

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, the module may be implemented in a form of an application-specific integrated circuit (ASIC).

The term “unit” or the like used herein may refer to a software or hardware component, such as a field-programmable gate array (FPGA) or an application-specific integrated circuit (ASIC), and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the embodiments will be described in detail with reference to the accompanying drawings. When describing the examples with reference to the accompanying drawings, like reference numerals refer to like components and a repeated description related thereto will be omitted.

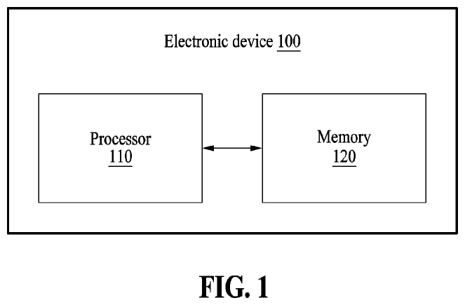

FIG. 1 is a schematic block diagram of an electronic device according to one embodiment.

According to one embodiment, an electronic device 100 may implement an optical network on a compute express link (CXL). The electronic device 100 may use an optical physical layer to overcome a disadvantage (e.g., a limitation in a physical connection distance, one-to-one connection) of a CXL physical layer (e.g., a flexbus physical layer). The electronic device 100 may compensate for a CXL physical layer technique and a CXL link layer technique.

The electronic device 100 may include an optical network interface (NI) device, an optically networked (ON)-CXL device, or an optical network interface card (NIC).

The optical NI device or the ON-CXL device may be implemented as a built-in state in a device supporting CXL protocol or may be implemented in a separate device and attached to the device supporting CXL protocol. The optical NI device or ON-CXL device may be implemented in a software module. The optical NIC may be implemented in a separate device from the device supporting CXL protocol and may be attached to the device supporting CXL protocol.

The device supporting CXL protocol may be a device for supporting a CXL protocol. The device supporting CXL protocol may be divided into a host device and a CXL device (e.g., an accelerator, a memory expander, and a device including an attached memory). The device supporting CXL protocol may include a CXL interface or an ON-CXL interface.

The electronic device 100 may use an expandable flexible flit passing through an optical physical layer (e.g., an ON-CXL optical physical layer). The expandable flexible flit may have a function of being adjustable in length. The expandable flexible flit may be set to validate a limited number of data headers to prevent rollover when transporting a data header and a cache line (or a line of a memory). The expandable flexible flit may expand by considering a single flit transfer of corresponding cache line (or a line of a memory) data to prevent rollover. The expandable flexible flit may maintain the flit size of CXL when both data header and cache line (or a line of a memory) data do not exist.

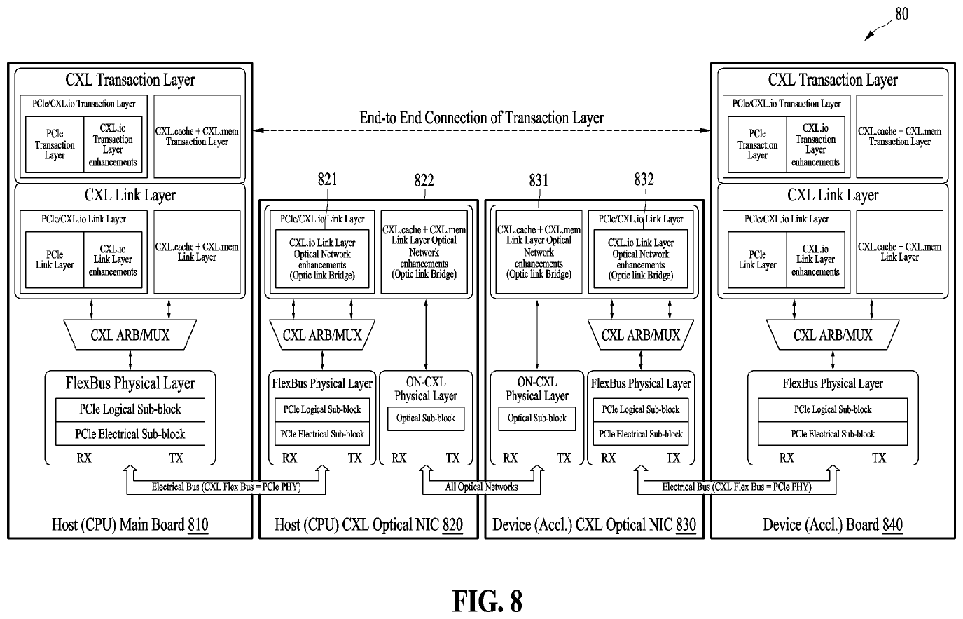

The electronic device 100 may be connected (e.g., see FIG. 8) to another ON-CXL interface device, another optical NI device, or another optical NIC through an optical physical layer.

The electronic device 100 may be connected to another device without a physical connection distance limitation by using the expandable flexible flit and the optical physical layer (e.g., the ON-CXL optical physical layer). In addition, the electronic device 100 may enable multi-point connection and a switch may be applied to the electronic device 100. The electronic device 100 may connect a host device to another CXL device through an optical network.

The electronic device 100 may expand a heterogeneous computing scale by implementing scalability of the connection distance between devices and diversity of arrangement through the optical physical layer. The electronic device 100 may maintain cache coherence between heterogeneous processing devices participating in expanded heterogeneous computing while contributing to efficient data exchange.

Referring to FIG. 1, the electronic device 100 may include a processor 110 and a memory 120. As described above, the electronic device 100 may be implemented inside the device supporting CXL protocol or may be implemented as a separate device from the device supporting CXL protocol and may be attached to the inside of the device supporting CXL protocol. The electronic device 100 may also be implemented in a state in which the processor 110 and the memory 120 are not included therein.

The processor 110 may process data stored in the memory 120. The processor 110 may execute computer-readable code (e.g., software) stored in the memory 120 and instructions triggered by the processor 110 and may use data.

The processor 110 may be a hardware-implemented data processing device with a physically structured circuit to execute desired operations. For example, the desired operations may include code or instructions and data included in a program. The hardware-implemented data processing device may include, for example, a microprocessor, a CPU, a processor core, a multi-core processor, a multiprocessor, an ASIC, an FPGA, a graphics processing apparatus, and an accelerator.

The memory 120 may be generally attached to the processor 110 but may also exist in another separate physical board. The memory 120 may be implemented as a volatile memory device or a non-volatile memory device. The volatile memory device may be implemented as dynamic random-access memory (DRAM), static random-access memory (SRAM), thyristor RAM (T-RAM), zero capacitor RAM (Z-RAM), or twin transistor RAM (TTRAM). The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase-change RAM (PRAM), resistive RAM (RRAM), nanotube RRAM, polymer RAM (PoRAM), nano floating gate memory (NFGM), holographic memory, a molecular electronic memory device, or insulator resistance change memory.

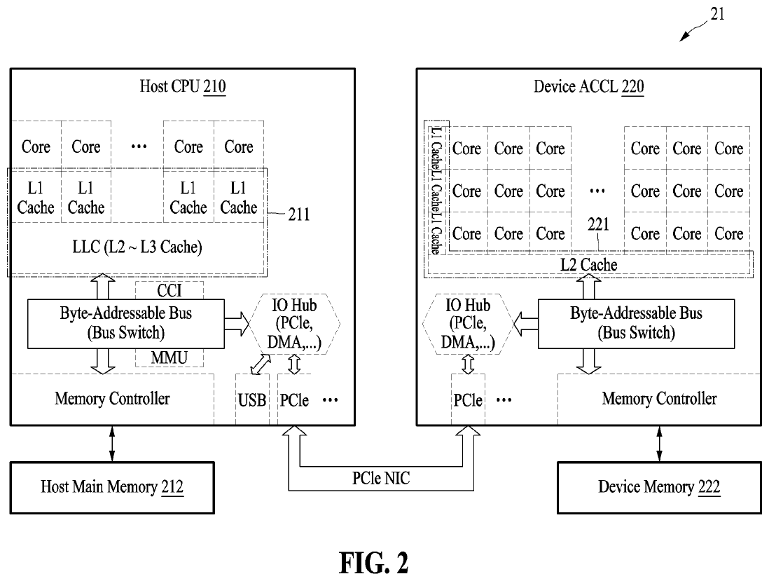

FIG. 2 is a diagram illustrating peripheral component interconnect express (PCIe) connecting a host device to a peripheral device.

Referring to FIG. 2, a computing system 21 for cooperating with a host device 210 (e.g., a host CPU) and an accelerator 220 may be identified. The host device 210 and the accelerator 220 may use an I/O bridge or an I/O hub (e.g., a PCIe) for mutually sharing data. A memory (e.g., 211 or 212) of the host CPU 210 and the accelerator 220, and the host CPU 210 and a memory (221 or 222) of the accelerator 220 may require protocol-based conversion for mutually accessing data.

The host device 210 and the accelerator 220 may convert data based on an input/output protocol and may indirectly share data using a PCIe technique and/or a direct memory access (DMA) controller.

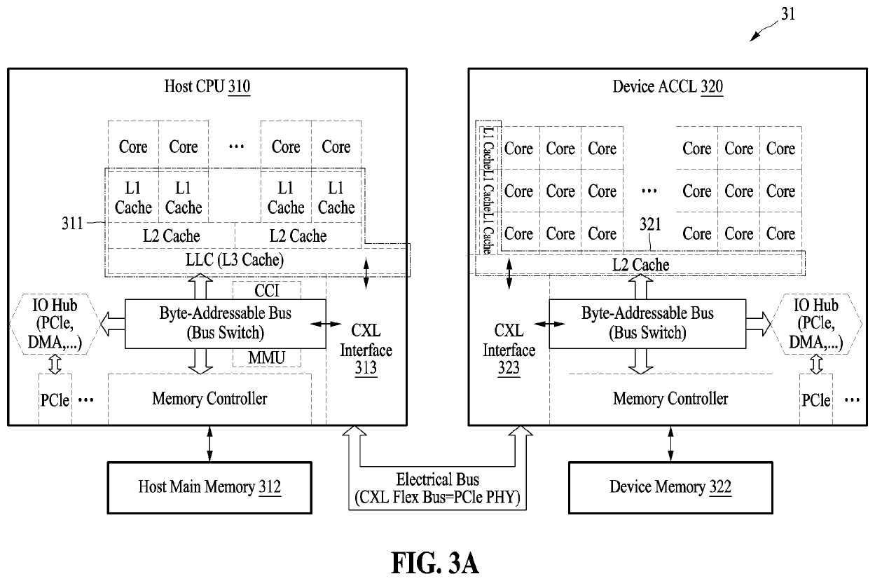

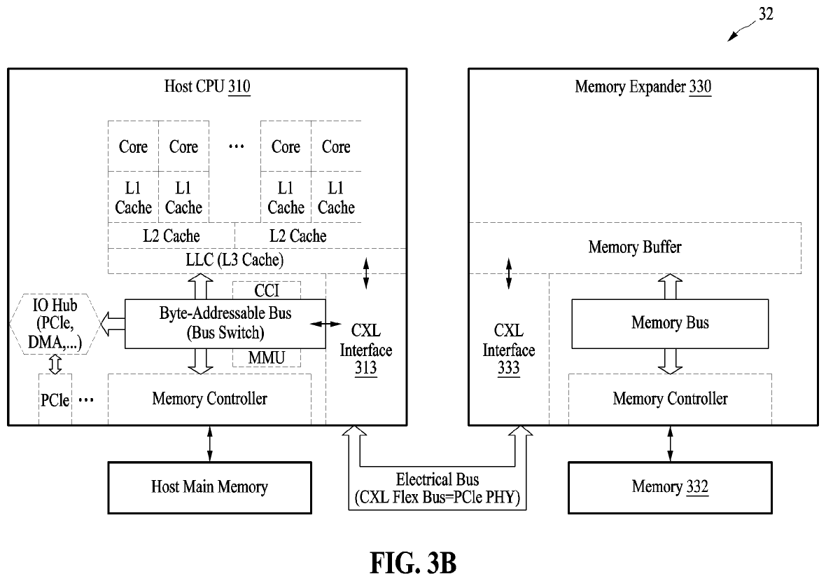

FIGS. 3A and 3B are diagrams illustrating a CXL interface connecting a host device to a peripheral device.

Referring to FIG. 3A, a host device (e.g., a host CPU) 310 and an accelerator 320 connected via a CXL interface may be identified. For heterogeneous computing, the CXL interface may concentrate on a cache (e.g., 311 or 321) that is accessible by each processing device and DRAM (e.g., 312 or 322).

For heterogeneous computing, the host device 310 and the accelerator 320 may support a CXL protocol (e.g., CXL.cache, CXL.mem, and CXL.io). A CXL interface 313 of the host device 310 and a CXL interface 323 of the accelerator 320 may maintain consistency of a given address in an operation using their cores, caches 311 and 321, and DRAMs (e.g., 312 and 322).

Referring to FIG. 3B, the host device (e.g., a host CPU) 310 and a memory expander 330 connected via a CXL interface may be identified. The memory expander 330 may be for expanding (e.g., adding a memory 332) the main memory 312 of the host device 310. The memory expander 330 may be operated regardless of cache coherence, however, when a memory is shared by two or more separate processing devices, a memory coherence protocol may be operated by a sharing host or accelerator and the memory expander 330 may partially support the CXL protocol (e.g., CXL.mem, CXL.io).

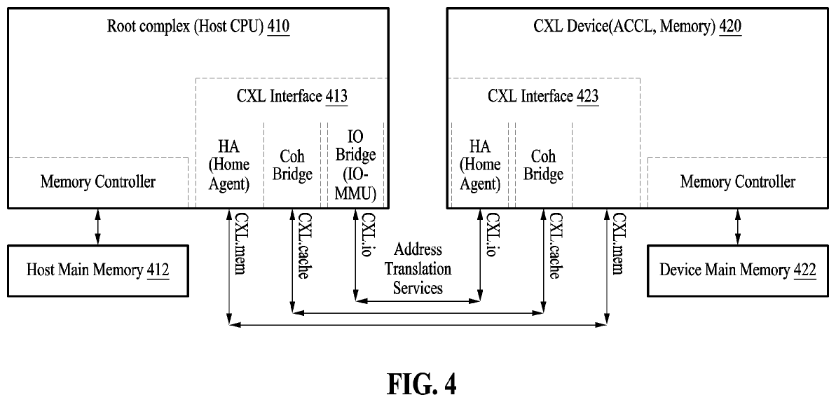

FIG. 4 is a diagram illustrating a CXL protocol.

Referring to FIG. 4, a functional diagram of CXL protocols may be identified. A CXL.io protocol may provide a standard interface to a CXL device 420 (e.g., a memory expander and an accelerator). The CXL.io protocol may define a command-based interface such that a host device 410 may access a resource of a CXL device 420. Similar to a PCIe.io protocol, the CXL.io protocol may support to search and configure the CXL device 420 of the host device 410.

A CXL.cache protocol may provide a standard interface for implementing a coherent cache layer. By using the CXL.cache protocol, a distributed cache layer structure across multiple devices may be generated, and thus, devices (e.g., 410 and 420) may efficiently share data while maintaining cache coherence.

A CXL.mem protocol may provide a high-speed interface for accessing a memory resource. The CXL.mem protocol may enable efficient data transfer between the host device 410 and the CXL device 420 (e.g., a memory expander) by providing a high-speed and low latency interface.

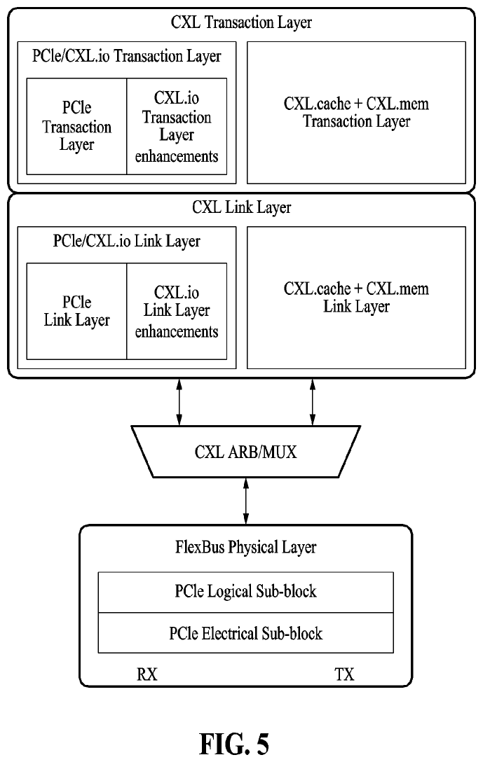

FIG. 5 is a diagram illustrating a CXL layer.

Referring to FIG. 5, in a CXL method, a protocol stack may be divided into three layers, a transaction layer, a link layer, and a physical layer (e.g., a flexbus physical layer). In communication between devices connected via a CXL interface, the three layers may perform their roles.

The CXL transaction layer may be a layer related to interaction of data (e.g., a cache and/or data stored in a memory) that is sharable by a heterogeneous processing device (e.g., a host device and a peripheral device connected to the host device). The CXL transaction layer may generate, process, and manage a transaction. The CXL transaction layer may define formats of a command and a response used for the transaction.

A CXL link layer may be a layer for generating and terminating header information, a frame, and/or a flit for mutual exchange of data between devices. The CXL link layer may manage physical connection between devices connected via the CXL interface.

A CXL physical layer (e.g., a flexbus physical layer) may convert a digital signal of the CXL link layer into an electrical signal that is transmittable to a physical medium (e.g., a copper cable, a printed circuit board (PCB), an electrical circuit). The CXL physical layer may manage a physical communication channel between devices including a signal, a timing, and/or a voltage level. The CXL physical layer may be a layer for utilizing an electrical physical layer of PCIe.

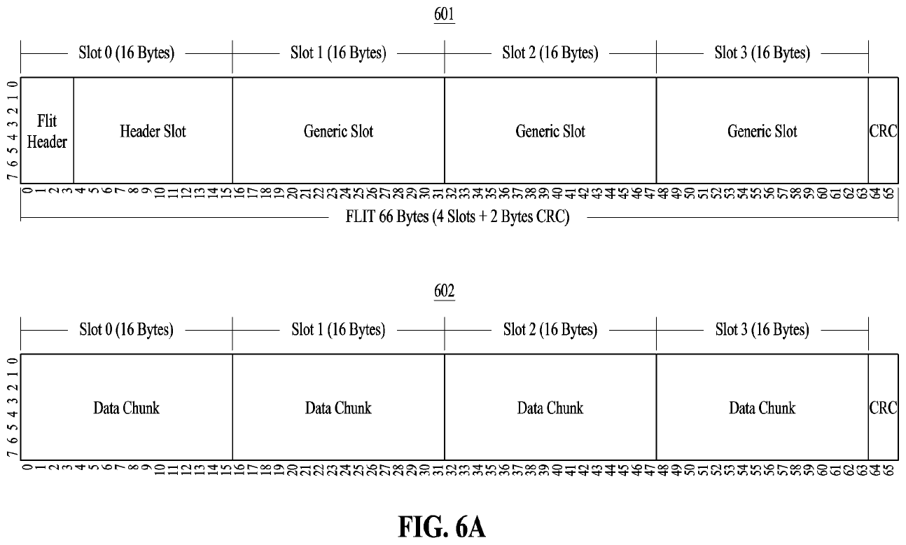

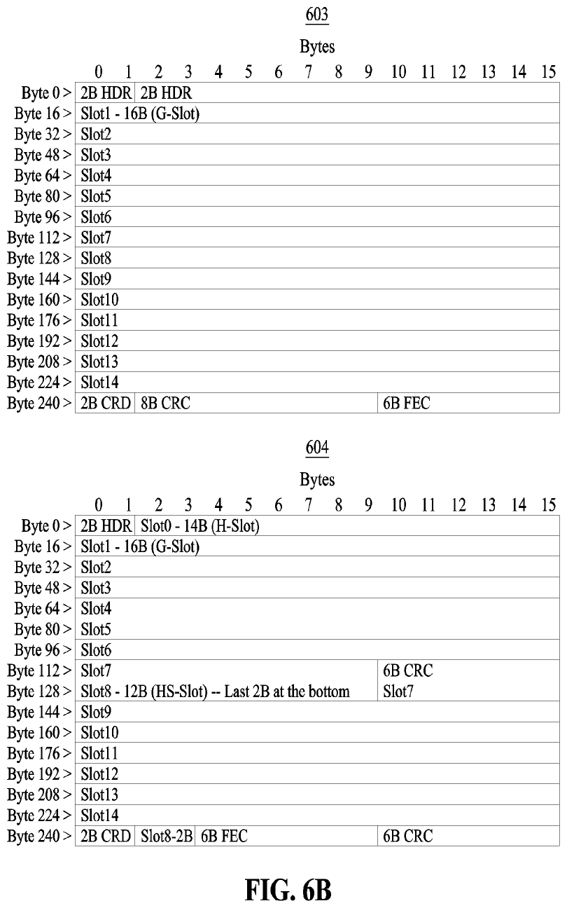

FIGS. 6A and 6B are diagrams illustrating a CXL flit.

Referring to FIG. 6A, examples of a 68-byte flit generated by a link layer may be identified. The flit may be a unit of data transmitted between devices connected using CXL. Flits 601 and 602 may include an area (e.g., 66 bytes) designated for information a transaction layer and an area (e.g., 2 bytes) designated for information of a link layer and May have a total length of 68 bytes.

The flits 601 and 602 may include 4 16-byte slots (e.g., slot 0 to slot 3). A slot may be classified into various types. Referring to the flit 601, a header slot including a flit header may be located in slot 0 and generic slots may be located in slots 1 to 3. Referring to the flit 602, all slots may consist of data chunks (e.g., data related to requests or responses of a CXL cache protocol and a CXL.mem protocol). The flits 601 and 602 may include 2-byte cyclic redundancy check (CRC).

In the case of a 68-byte flit mode, when cache line (or a line of a memory) data and a data header to be transferred exist, a logic responding to rollover may be required as the 68-byte flit size is exceeded.

Referring to FIG. 6B, examples of a 256-byte flit generated by a link layer may be identified. Flits 603 and 604 may be based on a PCIe flit. The flits 603 and 604 may each be configured to include a 2-byte header (2B HDR) instead of a 4-byte flit header and a 4-bit slot format (SlotFmt) for each slot to distinguish between slots. The flits 603 and 604 may distinguish H-Slot (H0 to H15) and G-Slot (G0 to G15) based on a slot location. The flits 603 and 604 may be constituted by more types of slots than the 68-byte flits, that is, the flits 601 and 602. The flits 603 and 604 may be expanded into HS-Slot (HS0 to HS12) that is an H subset slot.

In the case of a 256-byte flit mode, one or more data headers and cache line (or a line of a memory) data may be transported. However, because rollover of the data may occur based on the location of a flit of a slot related to the data header, a function to respond to rollover may be required.

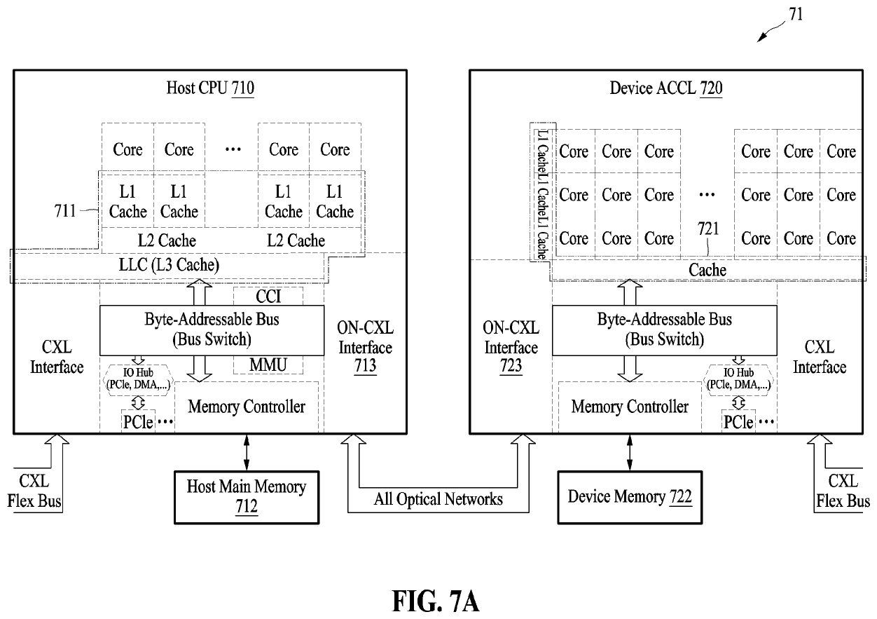

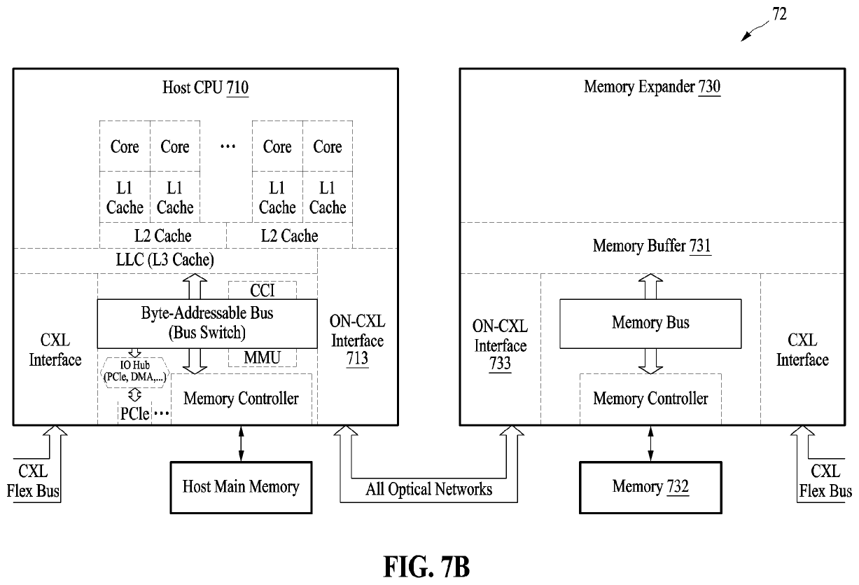

FIGS. 7A and 7B are diagrams illustrating a device supporting CXL protocol to which an optically networked (ON)-CXL interface is applied, according to one embodiment.

Referring to FIG. 7A, according to one embodiment, a host device (e.g., a host CPU) 710 and an accelerator 720 connected via ON-CXL interfaces 713 and 723 may be identified. The ON-CXL interface 713 or 723 may be utilized as a separate interface that may be optically connected rather than a CXL interface to maintain consistency of designated addresses in an operation using a core of a processing device (e.g., 710, 720), caches 711 and 721, and DRAMs 712 and 722. The host device 710 and the accelerator 720 may be CXL devices using the CXL interface (e.g., supporting a CXL protocol).

The host device 710 and the accelerator 720 in one embodiment may include ON-CXL interfaces and may enable optical connection via various optical fiber media through optical physical layers (e.g., an ON-CXL optical physical layer).

Referring to FIG. 7B, the host device (e.g., the host CPU) 710 and a memory expander 730 connected via the ON-CXL interfaces 713 and 733 may be identified. The ON-CXL interface may be a separate interface that may be optically connected rather than a CXL interface. The memory expander 730 may be a CXL device using the CXL interface (e.g., supporting a CXL protocol), which is the same as the host device 710 and the accelerator 720. The host device 710 and the memory expander 730 may include ON-CXL interfaces and may enable optical connection via various optical fiber media through optical physical layers.

However, types (e.g., any one of type 1, type 2, and type 3 defined by a CXL protocol) of the host device 710, the accelerator 720, and the memory expander 730 may be different.

The ON-CXL interfaces 713, 723, and 733 may implement an optical network on the CXL. The ON-CXL interfaces 713, 723, and 733 may utilize an optical physical layer to overcome a disadvantage (e.g., a limitation in a physical connection distance, one-to-one connection) of a CXL physical layer (e.g., a flexbus physical layer). The ON-CXL interfaces 713, 723, and 733 may compensate for a CXL physical layer technique and a CXL link layer technique.

The ON-CXL interfaces 713, 723, and 733 may utilize an expandable flexible flit passing through an optical physical layer. The expandable flexible flit may be an expandable flexible flit of which the length is adjustable. The expandable flexible flit may be set to validate a limited number of data headers to prevent rollover when transporting a data header and a cache line (or a line of a memory). The expandable flexible flit may expand by considering a single flit transfer of corresponding cache line (or a line of a memory) data to prevent rollover. The expandable flexible flit may maintain the flit size of CXL when a data header and cache line (or a line of a memory) data do not exist. The ON-CXL interface 713 may be connected to an ON-CXL interface (e.g., 723 and 733) through an optical physical layer (e.g., an ON-CXL optical physical layer).

The ON-CXL interface 713 may be connected to another ON-CXL interface (e.g., 723 and 733) without a physical connection distance limitation by using the expandable flexible flit and the optical physical layer (e.g., the ON-CXL optical physical layer). In addition, the ON-CXL interfaces 713, 723, and 733 may enable multi-point connection and a switch may be applied thereto. The ON-CXL interfaces 713, 723, and 733 may connect the host device 710 to another CXL device (e.g., 720 and 730) through an optical network.

The ON-CXL interfaces 713, 723, and 733 may expand the heterogeneous computing scale by implementing diversity of arrangement and scalability of the connection distance between devices through the optical physical layer. The electronic device 100 may maintain cache coherence among heterogeneous processing devices participating in expanded heterogeneous computing while contributing to efficient data exchange.

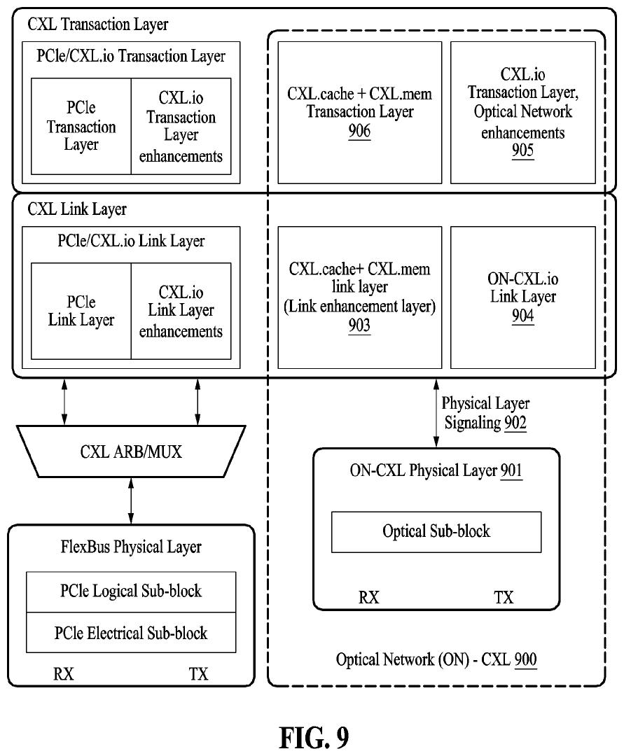

FIGS. 8 and 9 are diagrams illustrating an ON-CXL layer configuring an ON-CXL interface and a method of applying the ON-CXL interface, according to one embodiment.

Referring to FIG. 8, according to one embodiment, a host device (e.g., a mainboard) 810 may be connected to a CXL device (e.g., a device board) 840 through an optical network. Both the host device (e.g., a mainboard) 810 and the CXL device (e.g., an accelerator or a separate device board including a memory) 840 may support a CXL protocol and a CXL interface and may be a device supporting CXL.

The host device (e.g., a mainboard) 810 and the CXL device (e.g., a device board) 840 may be connected to each other through an optical NI device, optical NICs 820 and 830, or an ON-CXL interface device implementing the optical network. The ON-CXL interface device, the optical NI device, or the optical NICs 820 and 830 may accommodate both an electrical physical layer (e.g., a flexbus layer) of CXL and an optical physical layer of ON-CXL. The host device 810 may be physically connected to the ON-CXL interface device, the optical NI device, or the optical NIC 820 through the flexbus layer of the CXL interface. The ON-CXL interface device, the optical NI device, or the optical NIC 820 may be connected to another ON-CXL interface device, another optical NI device, or the other optical NIC 830 through an optical physical layer of the ON-CXL interface. The ON-CXL interface device, the optical NI device, or the optical NIC 830 may be physically connected to the CXL device 840 through a flexbus layer of the CXL interface.

Through the CXL interface (e.g., a flexbus layer), the host device 810 may transmit a CXL flit related to a request and/or a response of a CXL transaction layer to the ON-CXL interface device, the optical NI device, and the optical NIC 820. The CXL flit may be based on CXL.io or CXL.cachemem protocols (a CXL.mem protocol or a CXL.cache protocol).

Through an optical link bridge 822 of a link enhancement layer, the ON-CXL interface device, the optical NI device, or the optical NIC 820 may convert the CXL flit into an expandable flexible flit. The optical link bridge 822 of the link enhancement layer may be for enhancement of the CXL.cachemem protocol (the CXL.mem protocol and the CXL.cache protocol). An optical link bridge 822 of the link enhancement layer may be for enhancement of the CXL.io protocol. Because the CXL.io protocol may use a PCIe packet rather than using a flit, the optical link bridge 822 of the link enhancement layer may be for providing transparent connection between an ON-CXL.io packet and a CXL.io PCIe packet.

Through an optical physical layer applicable to CXL, the ON-CXL interface device, the optical NI device, or the optical NIC 820 may transmit the expandable flexible flit to another ON-CXL interface device, another optical NI device, or the other optical NIC 830. Through an optical link bridge 831 of a link enhancement layer, another ON-CXL interface device, another optical NI device, or the other optical NIC 830 may reconstruct the expandable flexible flit to a CXL flit. The optical link bridge 831 of the link enhancement layer may correspond to the optical link bridge 822 and the optical link bridge 832 may correspond to the optical link bridge 821.

Through the CXL interface (e.g., a flexbus layer), another ON-CXL interface device, another optical NI device, or the other optical NIC 830 may transmit the reconstructed CXL flit to the CXL device 840 (e.g., a device board). The reconstructed CXL flit may be terminated by the CXL device 840.

FIG. 8 is a diagram illustrating an ON-CXL layer configuring an ON-CXL interface and a method of applying the ON-CXL interface, according to one embodiment. Herein, when an ON-CXL interface device, an optical NI device, or an optical NIC 820 or 830 is configured in a separate chip from a host device or a CXL device that is a device supporting CXL protocol in general, the ON-CXL interface device, the optical NI device, or the optical NIC 820 or 830 may be collectively referred to as an ON-CXL interface device or an optical NI device. Particularly, when an ON-CXL interface device or an optical NI device is configured in a separate card board from a board in which a host device or a CXL device, which is a device supporting CXL protocol, is installed, the ON-CXL interface device or the optical NI device may be referred to as an optical NIC.

Referring to FIG. 9, an ON-CXL layer 900 may be identified. The ON-CXL interface device, the optical NI device, or the optical NICs 820 and 830 may be for expanding CXL layers.

An ON-CXL physical layer 901 (e.g., an optical physical layer) may be implemented in an optical fiber media technique. The ON-CXL physical layer 901 (e.g., an optical physical layer) may comply with the standard (e.g., an ethernet physical layer or an INFINIBAND physical layer accepting a data rate from giga bit per second (bps) to hundreds of giga bps and transmitting and receiving data through an optical transmitter and an optical receiver) of an IEEE 802.3 optical physical layer or an optical physical layer of INFINIBAND or may modify and apply standards of various optical physical layers supporting an optical transmission feature.

The ON-CXL physical layer 901 (e.g., an optical physical layer) and a link layer 903 (e.g., a link enhancement layer) may transmit and receive data through physical layer signaling 902. A physical layer signaling signal (PLS) may include a PLS data request signal for transmission to a physical layer, a PLS data indication signal for reception from the physical layer, and an indication signal of validity of received PLS data. Through a reconciliation sublayer (RS), the ON-CXL physical layer 901 (e.g., an optical physical layer) may be connected to the link enhancement layer.

In the link layer of ON-CXL related to the CXL.cachemem protocol (e.g., the CXL.mem protocol and the CXL.cache protocol), an enhanced link enhancement layer from the existing CXL link layer may exist and the link enhancement layer 903 may be a layer for generating and terminating an expandable flexible flit instead of a CXL flit. When the link enhancement layer 903 of the CXL.mem protocol and the CXL.cache protocol is implemented in a separate chip or device and linked with the existing CXL interface, the link enhancement layer 903 may include or correspond to the optical link bridge 822 for conversion between the expandable flexible flit and the CXL flit.

In ON-CXL, an ON-CXL.io packet may be used to process the CXL.io protocol (e.g., see 904 and 905). The ON-CXL.io packet may use a PCIe packet format without modification to minimize an implementation change of a CXL.io transaction layer. In addition, the ON-CXL.io packet may use an ON-CXL dedicated CXL.io transaction layer packet in a similar format to a flit to efficiently transmit information. The ON-CXL.io packet may be implemented in a CXL.io link layer packet that is suitable for an optical network, a PCIe format packet, or a flit type. Hereinafter, an expandable flexible flit utilized in the ON-CXL interface is described.

A layer shown in FIG. 9 is an ON-CXL layer configuring the ON-CXL interface of FIGS. 7A and 7B and including a link enhancement layer 903 and an ON-CXL physical link 901 and may be applied to an ON-CXL interface in a chip of a host device or a CXL device.

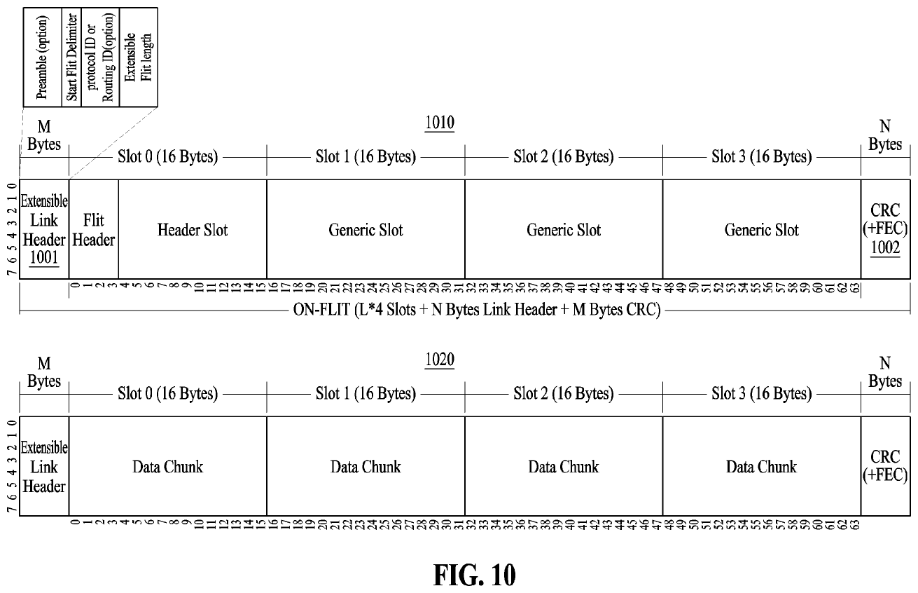

FIG. 10 is a diagram illustrating an extensible link header and an expandable flexible flit, according to one embodiment.

Referring to FIG. 10, according to one embodiment, an expandable flexible flit 1010 may not include a data header and related data in a 68B flit mode and may include an extensible link header 1001 of M bytes. The extensible link header 1001 may include an information field or a flit header for distinguishing a CXL protocol. The extensible link header 1001 may include an information field for distinguishing a message type of a flit. The extensible link header 1001 may include a start flit delimiter for distinguishing the start of a new flit. The extensible link header 1001 may include a preamble. The extensible link header 1001 may include an extendable flit length information field. An extendable flit length information field may include information (e.g., express the length) on the length of an extended flit to prevent rollover. The extendable flit length information field may include information on whether the length is extended or not. When extended, the size of the extendable flit length information field may be a multiple of 4 slot units or 64 bytes that is a data unit. Extensible link header information may expand to be applied to an optical physical layer by accepting or modifying header information of a CXL flit.

The expandable flexible flit 1010 may include a field 1002 of N bytes (e.g., a CRC field or a combined field of CRC and forward error correction (FEC)). The field 1002 may be a field for checking and correcting an error of all slots included in the expandable flexible flit 1010. The field 1002 may use a CXL CRC rule of octet without modification (e.g., a 2-byte field). The field 1002 may include 4 octet CRC used in a link layer of ethernet to increase an error detection rate of a slot (e.g., a 4-byte field). When the frequency of error occurrence is high, the field 1002 may add FEC to an 8-byte CRC (e.g., a 14-byte field). Since the field and the extensible link header included in the expandable flexible flit 1020 are substantially the same as those of the expandable flexible flit 1010, detailed descriptions thereof are omitted.

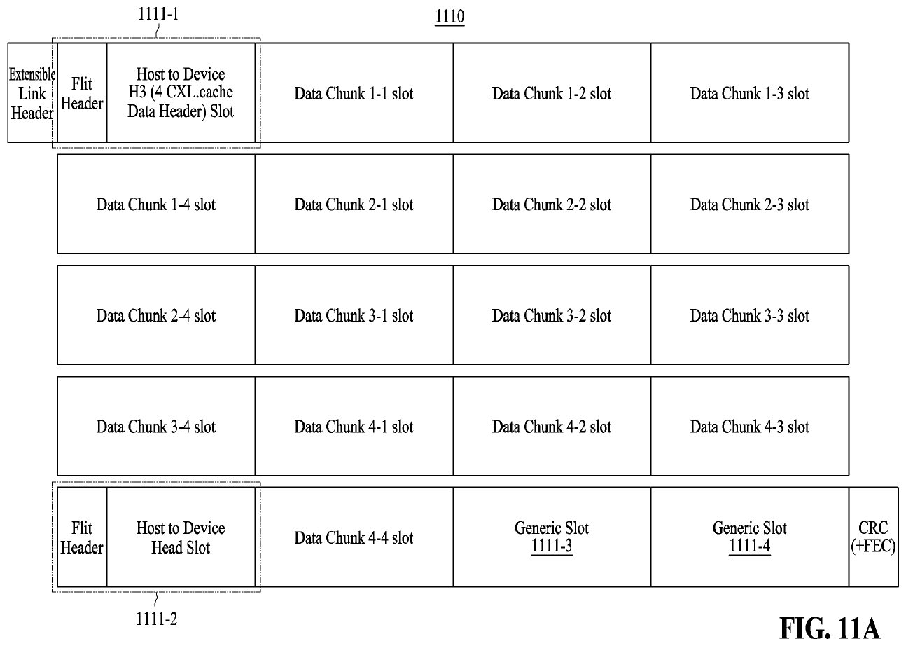

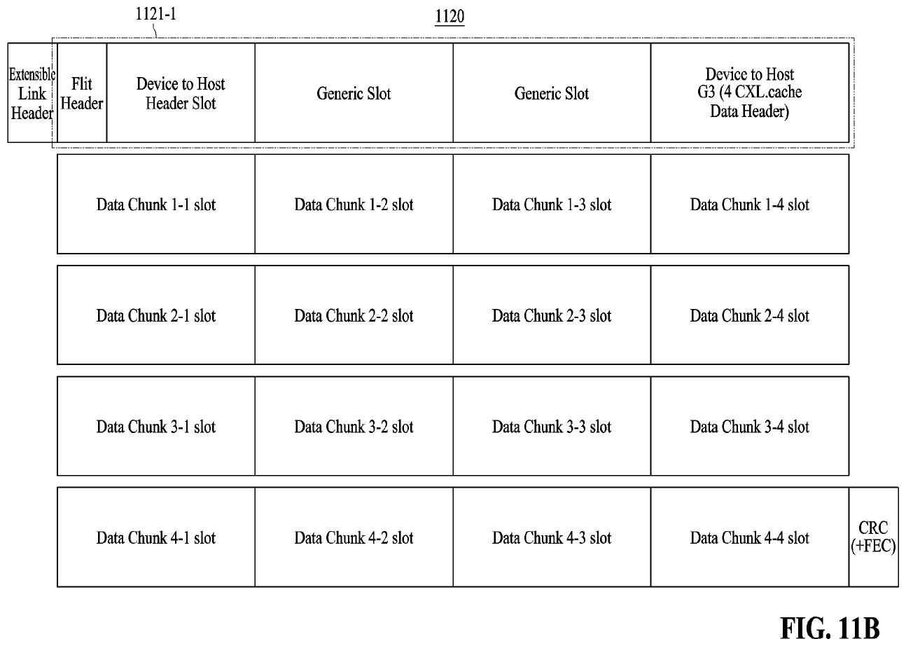

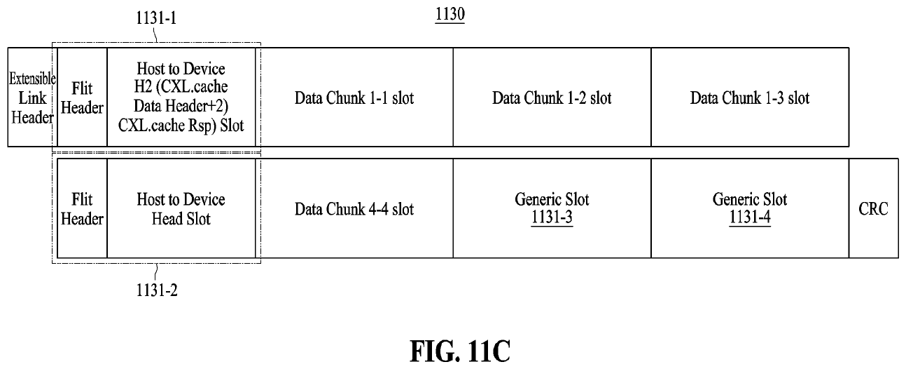

FIGS. 11A to 11C are diagrams illustrating expandable flexible flit according to one embodiment.

Referring to FIGS. 11A and 11B, according to one embodiment, examples of expandable flexible flits 1110 and 1120 including header slots 1111-1 and 1121-1 configured as a related data header when transferring 4 pieces of cache line (or a line of a memory) data may be identified and referring to FIG. 11C, an example of an expandable flexible flit 1130 including a header slot 1131-2 configured as a related data header when transferring cache line (or a line of a memory) data may be identified. The ON-CXL shown in FIGS. 11A to 11C may be an example of an ON-CXL (e.g., a first ON-CXL) of which the length is adjustable.

One data header may correspond to one piece of cache line (or a line of a memory) data (e.g., unit data used for data exchange based on a CXL.cachemem protocol). One piece of cache line (or a line of a memory) data (e.g., data chunk 1-1 to data chunk 1-4) may correspond to 4 slots. A slot may have the length of 16 bytes. When a slot includes a data header, multiple data headers may be included in one slot. That is, one piece of cache line (or a line of a memory) data may have a length of 64 bytes.

Referring to the expandable flexible flit 1110, when all 4 data headers included in one slot in one data stream are valid, after the slot 1111-1 containing the data header, multiple cache lines (or lines of a memory) may follow in the form of data chunk like 4 pieces of cache line (or a line of memory) data follow. 4 consecutive pieces of cache (or a line of a memory) data (e.g., data chunk 101 to data chunk 4-4) of the expandable flexible flit (e.g., ON-CXL slot) 1110 may have a length of a multiple of cache lines (or lines of a memory) without a head slot in the middle of the data chunk based on a partial flit generation rule (68B flit mode) of the CXL, that is, a length of 256 bytes. A header and a general slot of the non-consecutive ON-expandable flexible flit (e.g., CXL flit) 1110 of data chunk may be used to transmit or receive a request or a response that do not involve data.

As described with reference to FIG. 10, the expandable flexible flit 1110 may further include an extensible link header (e.g., 1001) of M bytes and CRC (or CRC combined with FEC) (e.g., 1002) of N bytes. The expandable flexible flit 1110 may have a length up to M (e.g., the extensible link header)+64 (e.g., a header slot and a general slot)+256 (e.g., 4 pieces of cache line data)+N (e.g., CRC or CRC combined with FEC) bytes. The expandable flexible flit 1110 may have a slot in an H3 slot type (4 CXL.cache data headers (4 data headers)) and may be a flit followed by 4 pieces of cache line (or a line of a memory) data.

Referring to FIG. 11B, the expandable flexible flit 1120 may have a slot of a G3 slot type (4 CXL.cache data headers (4 data headers)) and may be a flit followed by 4 pieces of cache line (or a line of a memory) data. The expandable flexible flit 1120 may be an example that a data header appears in a general slot. Unlike the expandable flexible flit 1110, the expandable flexible flit 1120 may be configured by one header slot (e.g., see 1111-1, 1111-2, and 1121).

Referring to FIG. 11C, the expandable flexible flit 1130 may have a slot of an H2 slot type CXL.cache data header+2 CXL.cache Rsp (one data header and two responses) and may be a flit followed by one piece of cache line (or a line of a memory) data. The expandable flexible flit 1130 may include a header slot 1131-1 including one data header. The expandable flexible flit 1130 may have a length of M (e.g., the extensible link header)+64 (e.g., a header slot and a general slot)+64 (e.g., cache line (or a line of memory) data)+N (e.g., CRC or CRC combined with FEC) bytes.

That is, the lengths of the expandable flexible flits 1110, 1120, and 1130 may be adjusted based on the number of valid data headers among the data headers. The expandable flexible flits 1110, 1120, and 1130 may contain one data stream including 4 valid data headers. The expandable flexible flits 1110, 1120, and 1130 may be a flit to which no rollover occurs (e.g., when transmitting a data stream that is larger than the maximum length of a single flit or when the number of slots remaining in one flit is less than the number of slots to be used by cache line (or a line of a memory) data to be transmitted, divide and transmit one data stream to two flits) for a data stream (e.g., one data stream including 4 data headers). The expandable flexible flits 1110, 1120, and 1130 may be a flit of which the length is adjustable. The expandable flexible flit may be implemented as a fixed-length flit in a 256B flit mode. To prevent rollover, the fixed-length flit (e.g., a 256 flit mode) may include a limited number of data headers or the data header and cache line (or a line of a memory) data may not exist. Referring to FIG. 6B, the fixed-length flit may be based on the flit 603 or 604 (e.g., a 256 flit mode) having a length of 256 bytes. Referring to FIG. 6B, in the flit 603 or 604 having a length of 256 bytes, the number of slots that may be occupied by cache line (or a line of a memory) data may be 13 or 14. Similarly, the number of data headers of the fixed-length flit (a 256 flit mode) may be up to 4. However, in this case, 16 slots (e.g., 16 slots that may be occupied by 4 pieces of cache line (or a line of a memory) data) may be required. Accordingly, the number of data headers of the fixed-length flit (a 256 flit mode) may be limited to 3 (e.g., 12<13, 14). The fixed-length flit (a 256 flit mode) may be a flit to which no rollover occurs for a data stream (e.g., one data stream including 3 data headers).

Because the main advantage of the expandable flexible flit is that transmission and reception may be achieved without rollover when transmitting cache line (or a line of a memory) data in the 64-byte unit, while transmitting and receiving a request and a response without cache line (or a line of a memory) data, transmission and reception may be available after adapting to CRC and FEC suitable for an optical physical layer and an extensible link header required for the optical physical layer in the 68B flit mode of FIG. 6A or the 256B flit mode of FIG. 6B. When rollover occurs, in both of the 68B flit mode and the 256B flit mode, the length of flit may change to a multiple of the cache line (or a line of a memory) data length (64-byte unit).

When a CXL protocol is expanded as a plurality of host devices and a plurality of peripheral devices are connected to each other via a switch beyond maintaining consistency between one host device and one peripheral device (a CXL device), it may be difficult to identify a data chunk flit or additional processing logic and time may be consumed if a data header and data (e.g., cache line (or a line of a memory) data) exists in different flits (e.g., if rollover occurs).

The ON-CXL interface may implement diversity of arrangement and scalability of the connection distance between devices through an optical physical layer and an expandable flexible flit in which transmission of data is limited and the length is fixed, and/or an ON-CXL expandable flexible flit of which the length is adjustable. In addition, the ON-CXL interface may expand the heterogeneous computing scale. The ON-CXL interface may maintain cache coherence between heterogeneous processing devices participating in expanded heterogeneous computing while contributing to efficient data exchange.

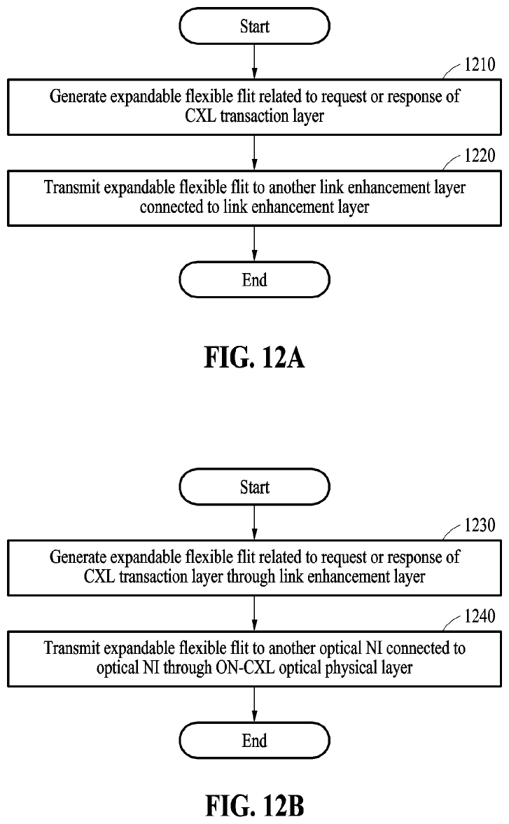

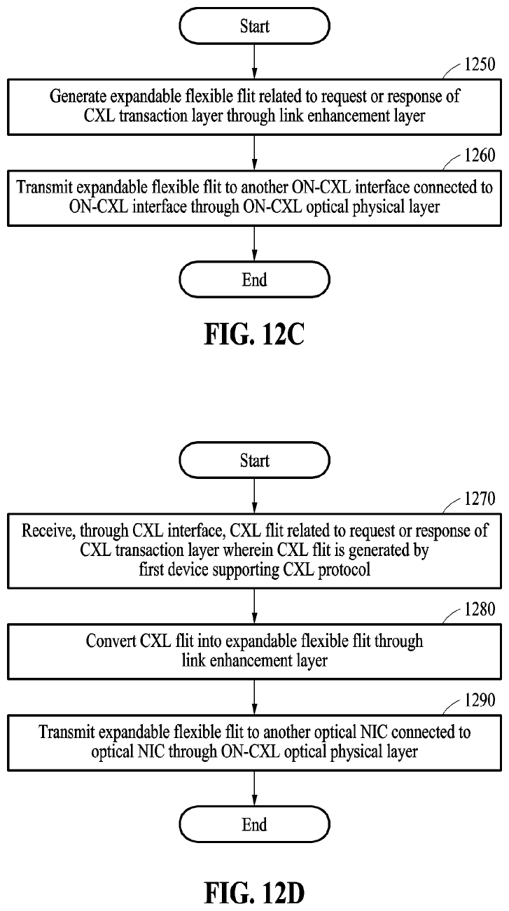

FIGS. 12A to 12D are diagrams illustrating a link enhancement layer, an operating method of an optical NI, an ON-CXL interface, and an operating method of an optical NIC.

Referring to FIG. 12A, according to one embodiment, a flowchart of operations of a link enhancement layer may be identified.

In operation 1210, the link enhancement layer (e.g., the link enhancement layer 903 of FIG. 9) may generate an expandable flexible flit related to a request or a response of a CXL transaction layer.

In operation 1220, the link enhancement layer 903 may transmit the expandable flexible flit to another link enhancement layer connected to the link enhancement layer 903. The expandable flexible flit may be terminated by the other link enhancement layer.

Referring to FIG. 12B, according to one embodiment, a flowchart of operations of an optical NI may be identified.

In operation 1230, an optical NI (e.g., the optical NI 900 of FIG. 9) may generate an expandable flexible flit related to a request or a response of a CXL transaction layer through the link enhancement layer 903.

In operation 1240, the optical NI 900 may transmit the expandable flexible flit to another optical NI connected to the optical NI 900 through an ON-CXL physical layer (e.g., the ON-CXL optical physical layer 901). The expandable flexible flit may be terminated by a link enhancement layer of the other optical NI.

Referring to FIG. 12C, according to one embodiment, a flowchart of operations of an ON-CXL interface may be identified.

In operation 1250, the ON-CXL interface (e.g., the ON-CXL interface 713 of FIG. 7A) may generate an expandable flexible flit related to a request or a response of a CXL transaction layer through a link enhancement layer.

The ON-CXL interface 713 may transmit the expandable flexible flit to another ON-CXL interface (e.g., the ON-CXL interface 723 of FIG. 7A or the ON-CXL interface 733 of FIG. 7B) connected to the ON-CXL interface 713 through an optical physical layer. The expandable flexible flit may be terminated by a link enhancement layer of the other ON-CXL interfaces 723 and 733.

Referring to FIG. 12D, according to one embodiment, a flowchart of operations of an optical NIC may be identified.

In operation 1270, an optical NIC (e.g., the optical NIC 820 of FIG. 8) may receive a CXL flit related to a request or a response of a CXL transaction layer via a CXL interface (e.g., a flexbus physical layer), wherein the CXL flit is generated by a first device supporting CXL protocol (e.g., the host 810 of FIG. 8).

The optical NIC 820 may convert the CXL flit into an expandable flexible flit through a link enhancement layer (e.g., the optical link bridge 822 of FIG. 8).

The optical NIC 820 may transmit the expandable flexible flit to another optical NIC (e.g., the optical NIC 830 of FIG. 8) connected to the optical NIC 820 through the ON-CXL optical physical layer. The expandable flexible flit may be reconstructed as a CXL flit through the link enhancement layer of the other optical NIC 830. The reconstructed CXL flit may be transmitted to a second device supporting CXL protocol (e.g., the CXL device 840 of FIG. 8) through a CXL interface (e.g., a flexbus physical layer) of the other optical NIC 830. The reconstructed CXL flit may be terminated by the second device supporting CXL protocol (e.g., 840). The CXL flit may be generated or terminated by the device supporting CXL protocol (e.g. 840 and 810) and conversion between the CXL flit and the expandable flexible flit may be performed by the optical NICs 830 and 820.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The units described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A method of operating a link enhancement layer, the method comprising:
generating an expandable flexible flit related to a request or a response of a compute express link (CXL) transaction layer; and
transmitting the expandable flexible flit to another link enhancement layer connected to the link enhancement layer,
wherein the expandable flexible flit is terminated in the other link enhancement layer.

2. The method of claim 1, wherein the expandable flexible flit is transmitted or received through an optically networked (ON)-CXL optical physical layer.

3. The method of claim 1, wherein the expandable flexible flit comprises:
at least one data header, and
an entirety of cache line data corresponding to the at least one data header to prevent rollover.

4. The method of claim 3, wherein the expandable flexible flit comprises:
a length that is adjustable based on a number of valid data headers, or
a limited number of data headers.

5. The method of claim 1, wherein the expandable flexible flit does not include a data header or cache line data to prevent rollover.

6. The method of claim 1, wherein the expandable flexible flit comprises:
an extensible link header comprising at least one of:
an information field for distinguishing a CXL protocol;
an information field for distinguishing a message type of a flit;
an extendable flit length information field comprising information on the length of an extended flit; and
a start flit delimiter for distinguishing a start of a new flit.

7. The method of claim 2, wherein the optical physical layer complies with a standard of an optical physical layer of IEEE 802.3 or an optical physical layer of Infiniband.

8. A method of operating an optical network interface (NI), the method comprising:
generating an expandable flexible flit related to a request or a response of a compute express link (CXL) transaction layer through a link enhancement layer; and
transmitting the expandable flexible flit to another optical NI connected to the optical NI through an optically networked (ON)-CXL optical physical layer,
wherein the expandable flexible flit is terminated in a link enhancement layer of the other optical NI.

9. The method of claim 8, wherein the optical NI is able to be operated by interworking with a CXL interface.

10. The method of claim 8, wherein the expandable flexible flit comprises:
at least one data header, and
an entirety of cache line data corresponding to the at least one data header to prevent rollover.

11. The method of claim 10, wherein the expandable flexible flit comprises:
a length that is adjustable based on the number of valid data headers; or
a limited number of data headers.

12. The method of claim 8, wherein the expandable flexible flit does not include a data header or cache line data to prevent rollover.

13. The method of claim 8, wherein the expandable flexible flit comprises:
an extensible link header comprising at least one of:
an information field for distinguishing a CXL protocol;
an information field for distinguishing a message type of a flit;
an extendable flit length information field comprising information on the length of an extended flit; and
a start flit delimiter for distinguishing a start of a new flit.

14. The method of claim 8, wherein the optical physical layer complies with a standard of an optical physical layer of IEEE 802.3 or an optical physical layer of Infiniband.

15. A method of operating an optically networked compute express link (ON-CXL) interface, the method comprising:
generating an expandable flexible flit related to a request or a response of a CXL transaction layer through a link enhancement layer; and
transmitting the expandable flexible flit to another ON-CXL interface connected to the ON-CXL interface through an ON-CXL optical physical layer,
wherein the expandable flexible flit is terminated in a link enhancement layer of the other ON-CXL interface.

16. The method of claim 15, wherein the expandable flexible flit comprises:
at least one data header, and
an entirety of cache line data corresponding to the at least one data header to prevent rollover.

17. The method of claim 16, wherein the expandable flexible flit comprises:
a length that is adjustable based on the number of valid data headers; or
a limited number of data headers.

18. The method of claim 15, wherein the expandable flexible flit does not include a data header or cache line data to prevent rollover.

19. The method of claim 15, wherein the expandable flexible flit comprises:
an extensible link header comprising at least one of:
an information field for distinguishing a CXL protocol;
an information field for distinguishing a message type of a flit;
an extendable flit length information field comprising information on the length of an extended flit; and
a start flit delimiter for distinguishing a start of a new flit.

20. The method of claim 15, wherein the ON-CXL interface is implemented in optical network interface card (NIC) that is a separate device and attached to a device supporting CXL protocol;
wherein the optical NIC is configured to:
receive a compute express link (CXL) flit related to a request or a response of a CXL transaction layer, wherein the CXL flit is generated by a first device supporting CXL protocol;
convert the CXL flit into an expandable flexible flit through a link enhancement layer; and
transmit the expandable flexible flit to another optical NIC connected to the optical NIC through an optically networked (ON)-CXL optical physical layer,
wherein the expandable flexible flit is reconstructed as a CXL flit through a link enhancement layer of the other optical NIC, and
the reconstructed CXL flit is transmitted to a second device supporting CXL protocol through a ON-CXL interface of the other optical NIC and is terminated by the second device supporting CXL protocol.
